(19) United States
(12) Patent Application Publication
(10) Pub. No.: US 2004/0128477 A1
(43) Pub. Date: Jul. 1, 2004

(54) Early access to microcode ROM

(75) Inventors: G. Glenn Henry, Austin, TX (US); Dinesh K. Jain, Austin, TX (US); Terry Parks, Austin, TX (US)

Correspondence Address: HUFFMAN LAW GROUP, P.C., 1832 N. CASCADE AVE., COLORADO SPRINGS, CO, 80907-7449, US

(73) Assignee: IP-First, LLC, Fremont, CA

(21) Appl. No.: 10/735,996

(22) Filed: Dec. 15, 2003

Related U.S. Application Data
(60) Provisional application No. 60/433,550, filed on Dec. 13, 2002.

(51) Int. Cl. G06F 9/30

(52) U.S. Cl. 712/207; 712/245

(57) ABSTRACT

An apparatus and method are provide for precluding stalls in a microprocessor pipeline due to microcode ROM access delay. The apparatus includes a micro instruction queue and early access logic. The micro instruction queue provides a plurality of queue entries to register logic. Each of the plurality of queue entries includes first micro instructions and a microcode entry point. All of the first micro instructions correspond to an instruction. The microcode entry point is coupled to the first micro instructions. The microcode entry point is configured to point to second micro instructions stored within a microcode ROM. The early access logic is coupled to the micro instruction queue. The early access logic employs the microcode entry point to access the microcode ROM prior to when the each of the plurality of queue entries is provided to the register logic, whereby a first one of the second micro instructions is provided to the register logic when the first one of the second micro instructions is required by the register logic.

### CROSS-REFERENCE TO RELATED APPLICATIONS

This application claims the benefit of U.S. Provisional Application No. 60/433550, filed on Dec. 13, 2002, which is herein incorporated by reference for all intents and purposes.

### BACKGROUND OF THE INVENTION

1. Field of the Invention

This invention relates in general to the field of microelectronics, and more particularly to an apparatus and method for precluding slips in a microprocessor pipeline due to microcode ROM access delay.

2. Description of the Related Art

A present day microprocessor executes application programs that consist of a sequence of instructions, where the instructions comport with a particular instruction set architecture (ISA). For example, an x86-compatible microprocessor executes application programs that have been coded with instructions comporting with the x86 ISA. The instructions are generally stored in memory and are fetched as required for execution by the microprocessor.

The types of operations and their associated complexities that are prescribed by instructions taken from any given ISA vary considerably. At one extreme, an instruction may direct that contents of a register be complemented. To execute this instruction requires a single, simple operation to be performed by the microprocessor. At the other extreme, another instruction from within same ISA may direct that the tangent be computed of the contents of a register. And to compute a tangent requires perhaps hundreds of operations to be performed.

For many different reasons, including those noted above, most microprocessors do not implement logic that directly executes instructions at the ISA level. Rather, the microprocessors implement logic that executes a set of lower-level instructions. These lower-level instructions are specifically tailored by designers of the microprocessors to exploit advantageous features of a given microprocessor's architecture which are not visible at the ISA level, but yet which result in increased execution speeds, increased efficiencies, and other advantages. These sets of tailored instructions are known by those in the art as micro instructions, native instructions, or microcode. Accordingly, when one of the aforementioned microprocessors fetches an ISA-level instruction from memory for execution, the instruction is first translated into a corresponding sequence of micro instructions that prescribes one or more sub-operations to be performed by the microprocessor, where complete execution of all of the sub-operations achieves execution of the operation prescribed by the instruction. Following translation, the microprocessor executes the corresponding sequence of micro instructions to perform the prescribed sub-operations.

Two classes of techniques are employed to translate instructions into corresponding sequences of micro instructions. These classes are typically known as direct translation and microcode read-only memory (ROM) lookup. Direct translation utilizes dedicated logic (called “translation logic”) to evaluate various fields within a fetched instruction and to correspondingly generate one or more micro instructions that prescribe the sub-operations to be performed by the microprocessor. For microcode ROM lookup, the fetched instruction is mapped to an address which specifies a location in a microcode ROM that contains one or more micro instructions that prescribe the sub-operations. The address is supplied to the microcode ROM and the micro instructions are provided by the microcode ROM for execution by the microprocessor.

Direct translation is advantageous in that dedicated logic is fast. The dedicated logic begins to generate micro instructions during the same clock cycle in which the instruction is provided. But as one skilled in the art will appreciate, to provide dedicated logic to identify and directly translate all of the instructions in a typical ISA would be very costly in terms of device complexity, power requirements, and real-estate on a die. In addition, because a unique logic design is required for each instruction within the typical ISA, once the unique logic design is complete, it is difficult to understand and requires significant design changes to implement minor micro instruction sequence changes.

The advantage of microcode ROM lookup is that this class of translation techniques is easily understandable and is extremely flexible with regard to making changes. Because micro instructions are programmed into a ROM device, changes can be implemented in a very straightforward manner by simply altering the programming of the ROM device. It is most often unnecessary to make any circuit changes at all. But the disadvantage of microcode ROM lookup is that this class of translation techniques is not near as fast as direct translation. More specifically, a ROM exhibits a delay between the time an address is provided and the time when a first micro instruction of a corresponding micro instruction sequence is issued from the ROM.

For this reason, it is not uncommon in the art to find that a combination of the above two techniques is employed to translate instructions into corresponding micro instruction sequences. For instance, direct translation is often provided to translate those instructions having micro instruction sequences consisting of number of micro instructions that can be directly translated within the delay that would be otherwise experienced by providing those instructions to a microcode ROM. And for those instructions that have a corresponding number of micro instructions that are greater than what could be generated during the microcode ROM access delay time, an address is provided to the microcode ROM for a second part of a corresponding micro instruction sequence while at the same time a first part of the micro instruction sequence is directly translated. Consequently, during the clock cycle following when the last instruction of the first part of the micro instruction sequence is directly generated, a first instruction from the second part of the micro instruction sequence is provided by the microcode ROM. In this manner, the access delay of the microcode ROM is effectively absorbed by direct translation and instruction translation efficiency of an associated microprocessor is maximized.

As alluded to above, changes to sequence of micro instructions that implement certain ISA-level instructions can be easily made to a design that employs microcode ROM lookup, or a combination of direct translation and microcode ROM lookup, for translation. Nevertheless, the present inventors have observed that there are cases where the attributes (e.g., overall capacity or entry size) of a given microcode ROM are insufficient to implement changes. In such cases, it is necessary to replace the microcode ROM with one whose attributes support the changes. Often these changes require greater capacity or entry size, and a ROM that provides these greater attributes typically exhibits a greater access delay.

So, the problem that the present inventors note is one in which a new microcode ROM presenting a greater delay is required to interoperate efficiently with existing direct translation logic. The direct translation logic is configured to generate a first part of a sequence of micro instructions during the access delay time of the former microcode ROM and, as a result, interoperation with the new microcode ROM results in slips or voids in a microprocessor pipeline between the time that the direct translation logic finishes generation of the first part of the sequence and the time when the new microcode ROM begins providing a second part of the sequence.

Therefore, what is needed is a microprocessor apparatus that precludes pipeline stalls during instruction translation which are due to microcode ROM access delay. Value

### SUMMARY OF THE INVENTION

The present invention, among other applications, is directed to solving the above-noted problems and addresses other problems, disadvantages, and limitations of the prior art. The present invention provides a superior apparatus and method for absorbing additional pipeline slips that result from microcode ROM access delay that is greater than what is compatible with existing direct translation logic. In one embodiment, a microprocessor apparatus is provided, for precluding a pipeline stall due to microcode ROM access delay. The microprocessor apparatus includes a plurality of micro instruction queue entries and early access logic. The plurality of micro instruction queue entries, each correspond to an instruction, and each of the plurality of micro instruction queue entries have a plurality of micro instructions and a microcode entry point. The early access logic is coupled to the micro instruction queue. The early access logic employs the microcode entry point to access a microcode ROM prior to when the microcode entry point is provided to register logic. As a result, the microcode ROM provides a first micro instruction to the register logic when the first micro instruction is required by said register logic.

One aspect of the present invention contemplates an apparatus for absorbing pipeline stalls associated with microcode ROM access delay. The apparatus has a micro instruction queue and early access logic. The micro instruction queue provides a plurality of queue entries to register logic. Each of the plurality of queue entries includes first micro instructions and a microcode entry point. All of the first micro instructions correspond to an instruction. The microcode entry point is coupled to the first micro instructions. The microcode entry point is configured to point to second micro instructions stored within a microcode ROM. The early access logic is coupled to the micro instruction queue. The early access logic employs the microcode entry point to access the microcode ROM prior to when the each of the plurality of queue entries is provided to the register logic, whereby a first one of the second micro instructions is provided to the register logic when the first one of the second micro instructions is required by the register logic.

Another aspect of the present invention comprehends a method for precluding microprocessor pipeline stalls resulting from microcode ROM access delay. The method includes obtaining a microcode entry point from within one of a plurality of micro instruction queue entries, the one of the plurality of micro instruction queue entries comprising first micro instructions; and employing the microcode entry point to access second micro instructions within a microcode ROM, wherein the employing is performed prior to when the one of the plurality of micro instruction queue entries is routed to a following pipeline stage, and whereby the employing enables the second micro instructions to be provided to the following pipeline stage without incurring the microprocessor pipeline stalls.

### BRIEF DESCRIPTION OF THE DRAWINGS

These and other objects, features, and advantages of the present invention will become better understood with regard to the following description, and accompanying drawings where:

FIG. 1 is a block diagram illustrating exemplary stages within an exemplary present day microprocessor;

FIG. 2 is a table depicting translation of several instructions into corresponding sequences of micro instructions by the microprocessor of FIG. 1;

FIG. 3 is a block diagram featuring a microprocessor apparatus according to the present invention for precluding pipeline stalls due to microcode ROM access delay;

FIG. 4 is a block diagram showing an alternative embodiment of the present invention that supports bypass of an empty micro instruction queue; and

FIG. 5 is a table illustrating translation of several instructions into corresponding sequences of micro instructions by the microprocessor according to the present invention.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

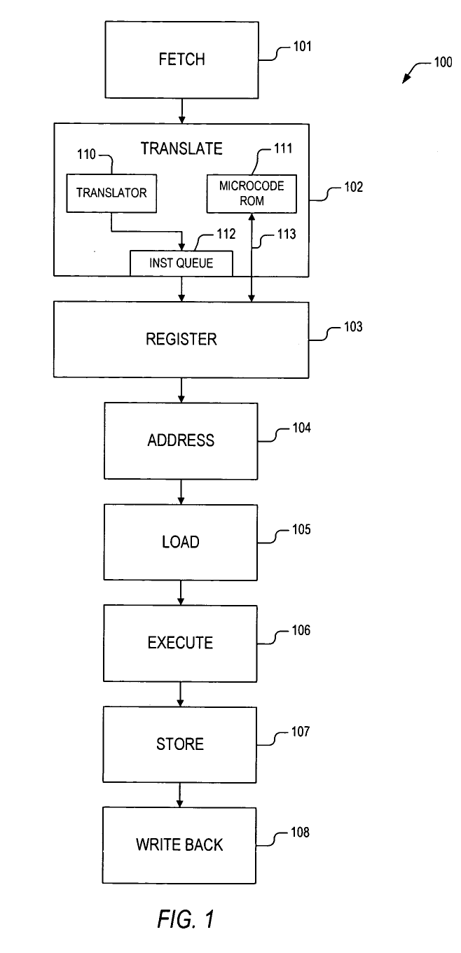

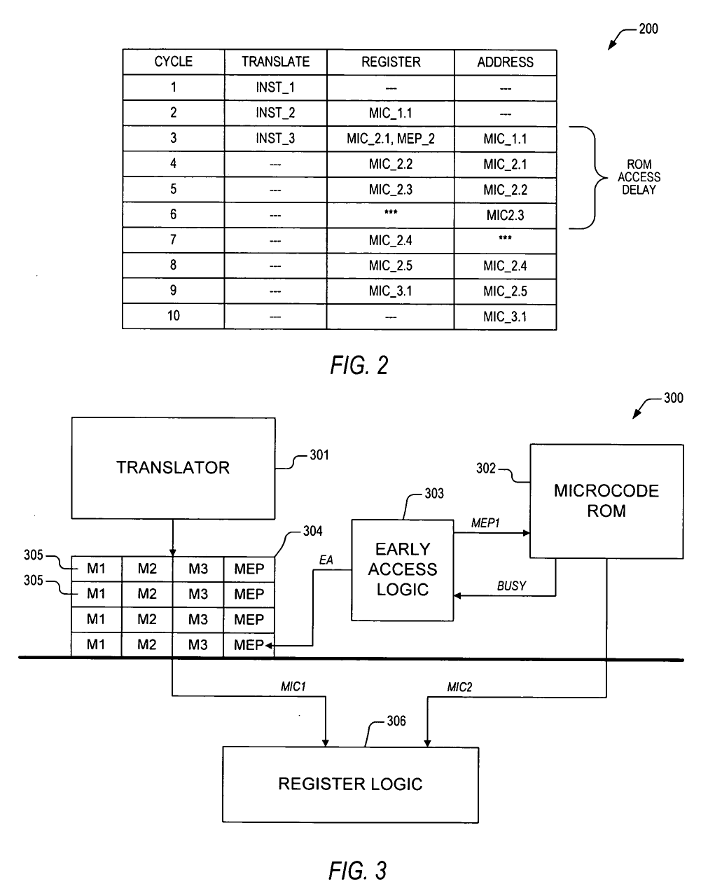

In view of the above background discussion on instruction translation and associated techniques employed within present day pipeline microprocessors for the generation of micro instruction sequences, a more detailed discussion of the problems noted by the present inventors will be provided with reference to FIGS. 1-2. Following this, a discussion of the present invention will be presented with reference to FIGS. 3-5. The present invention enables pipeline slips due to microcode ROM access delay to be effectively absorbed as micro instructions are issued by proving logic that accesses a comporting microcode ROM prior to when associated micro code entry points are provided to a following pipeline stage.

Referring to FIG. 1, a block diagram is presented illustrating exemplary stages within an exemplary present day microprocessor 100. The microprocessor 100 includes eight exemplary stages 101-108: a fetch stage 101, a translate stage 102, a register stage 103, an address stage 104, a load stage 105, an execute stage 106, a store stage 107, and a write back stage 108.

In operation, logic within the fetch stage 101 fetches instructions from a memory (not shown) for execution by the microprocessor 100. The fetched instructions are provided to the translate stage 102. As discussed above, logic within the translate stage 102 is employed to generate a corresponding sequence of micro instructions for each instruction that is to be executed by the microprocessor 100. The translate stage 102 includes a translator 110 that performs direct translation for some of the instructions and a microcode ROM 111 from which micro instruction sequences are provided as described above. The translator 110 is coupled to a micro instruction queue 112 and is capable of providing either 1) micro instructions; 2) a microcode ROM entry point; or 3) both micro instructions and a microcode ROM entry point for each of the fetched instructions. The microcode ROM entry point is an address that specifies a location within the microcode ROM 111 from which micro instructions are to be provided. The micro instruction queue 112 couples the translate stage 102 to the register stage. In addition, the register stage accesses the microcode ROM 111 via an access bus 113.

Logic within the register stage 103 is employed to access operands within a register file (not shown). When an entry from the micro instruction queue 112 is provided to the register stage 103, its microcode entry point is provided to the microcode ROM 111 via the access bus 113. If no micro instructions are provided in the entry by the translator 110, then the register stage inserts slips (also called “holes,” “stalls,” or “voids”) into the pipeline of the microprocessor 100 in synchronization with a pipeline clock signal (not shown) until the microcode ROM 111 begins providing micro instructions corresponding to the microcode entry point provided over bus 113. If no microcode entry point is provided in the entry, then the register stage 103 accesses operands within the register file as directed by provided micro instructions and provides the micro instructions and operands to the address stage 104 in synchronization with the pipeline clock signal. If both micro instructions and a microcode entry point are provided by the entry, then the register stage 103 accesses operands within the register file as directed by the micro instructions and provides the micro instructions and operands to the address stage 104 in synchronization with the pipeline clock signal while waiting for the microcode ROM 111 to supply additional micro instructions for execution via the access bus 113. In this manner, combined direct translation and microcode ROM lookup are employed to improve pipeline efficiency by maintaining a consistent flow of micro instructions to subsequent stages 103-108 of the microprocessor 100.

Micro instructions are routed from the register stage 103 is to the address stage 104 wherein memory addresses are generated for access (i.e., storage or retrieval) of operands in the memory. Computation of the memory addresses may employ operands retrieved from the register file, or operands immediately provided by the micro instructions, or a combination of register and immediate operands. The memory addresses, along with their associated micro instructions are provided to the load stage 105 in synchronization with the pipeline clock signal.

The load stage 105 retrieves memory operands from the memory. Typically, the memory operands are retrieved from a data cache (not shown), which is coupled to the memory via a memory bus. The memory operands, along with other operands and associated micro instructions are provided to the execute logic 106.

The execute logic 106 performs operations that are prescribed by micro instructions using their operands as passed down from previous stages 101-105 such as adding two operands together, complementing an operand, etc. These operations may involve integer operations, floating point operations, single-instruction/multiple-data (SIMD) operations, or any of a number of different types of operations that can be prescribed by present day instructions. Results of these operations are then provided in synchronization with the pipeline clock signal to the store stage 107.

Logic within the store stage 107 is employed to write results and operands to the memory, as directed by provided micro instructions. Like the load stage 105, the store stage is generally coupled to a data cache for performing store operations. The store stage 107 passes the micro instructions to the write back stage 108.

Logic within the write back stage 108 is employed to update registers within the register file with prescribed operands or results of the operations. Accordingly, micro instructions flow through each of the aforementioned pipeline stages 102-108 in synchronization with the clock signal so that operations can be concurrently executed in a manner substantially similar to operations performed on an assembly line. Operation at peak efficiency is achieved when each of the stages 102-108 is concurrently executing a micro instruction therein. The insertion of slips into the pipeline by any of the stages 101-108 causes inefficient operation that is observable in the form of decreased execution speed of a corresponding application program.

The block diagram of FIG. 1 is provided to teach the necessary elements of the present invention and thus, much of the logic within a present day microprocessor 100 has been omitted for clarity purposes. One skilled in the art will appreciate, however, that a present day microprocessor 100 comprises many stages and logic elements according to specific implementation, some of which have been aggregated herein. For instance, the load stage 105 could embody a cache interface stage followed by a cache line alignment stage.

As noted above, the present inventors have observed that pipeline inefficiencies occur when slips are inserted into a pipeline due to microcode ROM access delay. This problem will now be discussed in more detail with reference to FIG. 2.

Turning to FIG. 2, a table 200 is presented depicting translation of several instructions into corresponding sequences of micro instructions by the microprocessor 100 of FIG. 1. The table 200 depicts three columns TRANSLATE, REGISTER, ADDRESS that correspond to like-named stages 102, 103, 104 of the microprocessor 100. To focus on the problems that are addressed by the present invention, columns associated with the fetch stage 101 and stages 105-108 following the address stage 104 are not shown. In addition, a column CYCLE is depicted showing cycles of a pipeline clock signal that is employed by the microprocessor 100 to route instructions and micro instructions through its pipeline stages 101-108. Instructions before or after those of interest are designated “ - - - .” Inserted pipeline slips are designated “ * * * .”

During cycle 1, a first instruction INST_1 is provided from the fetch stage 101 to the translate stage 102. Therein, the first instruction INST_1 is directly translated into a single corresponding micro instruction MIC_1.1, which is provided to an entry in the micro instruction queue 112. For teaching purposes, assume for this example that the micro instruction queue 112 only has one entry. One skilled in the art will appreciate that a present day micro instruction queue 112 varies in size from one entry to approximately 10 entries, and that such an instruction queue is provided so that micro instructions can continue to be issued to subsequent stages 103-108 of the microprocessor 100 when stalling events occur in the fetch stage 101 or the translate stage 102.

During cycle 2, the first micro instruction MIC_1.1 is provided to the register stage 103. In addition, a second instruction INST_2 is provided to the translate stage 102. Therein, INST_2 is directly translated by the translator 110 into a first part of a corresponding micro instruction sequence having three micro instructions MIC_2.1:3 along with a microcode entry point MEP_2 that points to locations in the microcode ROM 111 containing a second part MIC_2.4:5 of the corresponding micro instruction sequence. In this example, the second part of MIC_2.4:5 of the corresponding micro instruction sequence consists of two micro instructions MIC_2.4, MIC_2.5 for clarity purposes, although one skilled in the art will appreciate that the second part could consist of perhaps hundreds of micro instructions. The three micro instructions MIC_2.1:3 along with the microcode entry point MEP_2 are then provided as an entry in the micro instruction queue 112.

During cycle 3, MIC_1.1 is provided to the address stage 104. Also during cycle 3, the register stage 103 retrieves the queue entry generated during cycle 2 and provides the microcode entry point MEP_2 to the microcode ROM 111 via the access bus 113. Micro instruction MIC_2.1 is processed by the register stage 103 during this cycle while micro instructions MIC_2.2 and MIC_2.3 are held in a holding register (not shown) or other buffering means. In addition, the translate stage 102 begins direct translation of a third instruction INST_3 into a corresponding micro instruction MIC_3.1, which is placed into the micro instruction queue 112.

During cycle 4, a first micro instruction MIC_2.1 from the first part MIC_2.1:3 of the micro instruction sequence corresponding to the second instruction INST_2 is issued to the address stage 104. Also during this cycle, the register stage 103 processes micro instruction MIC_2.2 while micro instruction MIC_2.3 remains held. In addition the register stage 103 continues to wait for the microcode ROM 111 to supply the second part MIC_2.4:5 of micro instruction sequence associated with the microcode entry point MEP_2.

During cycle 5, the second micro instruction MIC_2.2 from the first part MIC_2.1:3 is issued to the address stage 104 for execution. In addition during this cycle, the register stage 103 executes micro instruction MIC_2.3 and continues to wait for the microcode ROM 111 to supply the second part MIC_2.4:5 of the micro instruction sequence associated with the microcode entry point MEP_2.

During cycle 6, the third micro instruction MIC_2.3 from the first part MIC_2.1:3 is issued to the address stage 104 for execution. In addition during this cycle, the register stage 103 continues to wait for the microcode ROM 111 to supply the second part MIC_2.4:5 of the micro instruction sequence associated with the microcode entry point MEP_2. Accordingly, the register stage 103 experiences a slip * * * .

During cycle 7, since direct translation only supplied three micro instructions MIC_2.1:3 for the first part, the slip * * * incurred during cycle 6 is propagated to the address stage 104. In addition, the register stage 103 receives MIC_2.4 from the microcode ROM 111 during this cycle.

During cycle 8, MIC_2.4 is provided to the address stage 104 and MIC_2.5 is supplied to the register stage 103 from the microcode ROM 111.

During cycle 9, MIC_2.5 is provided to the address stage 104 and the register stage 103 retrieves MIC_3.1 from the micro instruction queue 112.

During cycle 10, MIC_3.1 is provided to the address stage.

The example of FIG. 2 is provided to highlight the problems noted by the present inventors with respect to microcode ROM access delay. More specifically, the slip * * * that is propagated to the address stage 104 during cycle 7 results in decreased application program speed and other pipeline inefficiencies because of a instruction queue configuration that provides only up to three micro instructions and a microcode entry point that must interoperate with a microcode ROM which exhibits a 4-cycle access delay. It is noted, however, that the specific number of micro instructions within the exemplary micro instruction queue 112 and the access delay of the microcode ROM 111 have been selected to highlight the problems addressed by the present invention. The present invention contemplates precluding access delays that correspond to other micro instruction queue entry sizes and microcode ROM access delays. For instance, if the exemplary microcode ROM 111 exhibited a 10-cycle access delay and the exemplary micro instruction queue entry provided five micro instructions and a corresponding microcode entry point, then every time translation of an instruction required a microcode ROM lookup, at least five slips * * * would be inserted into the pipeline.

As discussed above, use of combined direct translation and microcode ROM lookup is typically implemented in a microprocessor 100 by designing a translator 110 and associated micro instruction queue 112 that are matched to the microcode ROM access delay. For instance, if the microcode ROM 111 exhibits a 2-cycle delay, then the translator is configured to directly translate two micro instructions and each entry in the queue 112 is configured to hold the two micro instructions plus a corresponding microcode entry point. In this manner, the first micro instruction from the microcode ROM 111 is supplied to the register stage 103 during the cycle that it is required.

But the present inventors have observed that changes in micro instruction sequences, along with many other design changes known in the art, may present the case illustrated in FIG. 2 where the translator 110 and entries within the micro instruction queue 112 do not provide the capacity of direct translation to offset the delays incurred when accessing the microcode ROM. In such a case, it is noted that significant pipeline inefficiencies can occur.

The present invention overcomes the limitations discussed above by providing an apparatus and method for precluding pipeline slips in those cases where direct translation apparatus is not matched to the access delay of a particular microcode ROM. The present invention will now be discussed with reference to FIGS. 3-5.

Now referring to FIG. 3, a block diagram is provided featuring a microprocessor apparatus 300 according to the present invention for precluding pipeline stalls due to microcode ROM access delay. The microprocessor apparatus 300 includes a translator 301 that is coupled to a micro instruction queue 304. The translator 301 comprises logic, circuits, devices, or microcode (i.e., micro instructions or native instructions), or a combination of logic, circuits, devices, or microcode, or equivalent elements that are employed to directly translate instructions into associated sequences of micro instructions. The elements employed to perform direct translation within the translator 301 may be shared with other circuits, microcode, etc., that are employed to perform other functions within a microprocessor according to the present invention. The micro instruction queue 304 comprises a plurality of entries 305, where each of the entries 305 provides for routing of a plurality of micro instructions along with a corresponding microcode entry point MEP. In one embodiment, the micro instruction queue 304 comprises four entries 305 and each of the four entries provides for three micro instructions M1-M3 and a corresponding microcode entry point MEP.

Early access logic 303 is operatively coupled to the micro instruction queue 304 via bus EA and to a microcode ROM 302 via bus MEP1 and signal BUSY. Queue entries 305 are provided to register logic 306 within a register stage according to the present invention via bus MIC1. In addition, micro instructions are provided from the microcode ROM 302 to the register logic 306 via bus MIC2.

In operation, fetch stage logic (not shown) within a microprocessor according to the present invention fetches instructions from a memory (not shown) for execution. The fetched instructions are provided to the translator 301. The translator 301 in conjunction with the microcode ROM 302 generates a corresponding sequence of micro instructions for each instruction that is to be executed. The translator 301 performs direct translation for some of the instructions and the microcode ROM 302 provides second parts of micro instruction sequences as has been previously described. The translator 301 is capable of providing either 1) micro instructions M1-M3; 2) a microcode ROM entry point MEP; or 3) both micro instructions M1-M3 and a microcode ROM entry point MEP for each of the fetched instructions. The microcode ROM entry point MEP is an address that specifies a location within the microcode ROM 302 from which micro instructions are to be provided.

The early access logic 303 is configured to evaluate the entries 305 in the micro instruction queue 304 via bus EA and to provide microcode entry points MEP to the microcode ROM 302 via bus MEP1 prior to when the entries 305 are provided to the register logic 306. This enables the access delay associated with a particular microcode ROM 302 to be effectively absorbed while an associated queue entry 305 is still resident within the micro instruction queue 304. If the microcode ROM 302 is in the process of providing a second part of a microcode sequence corresponding to a previously provided entry point MEP, then signal BUSY is asserted. The early access logic 303 comprises logic, circuits, devices, or microcode (i.e., micro instructions or native instructions), or a combination of logic, circuits, devices, or microcode, or equivalent elements that are employed to evaluate entries 305 in the micro instruction queue 304 and to provide microcode entry points MEP to the microcode ROM 302. The elements employed to perform these functions within the early access logic 303 may be shared with other circuits, microcode, etc., that are employed to perform other functions within a microprocessor according to the present invention.

The register logic 306 is employed to access operands within a register file (not shown). When an entry 305 from the micro instruction queue 304 is provided to the register logic 306, rather than providing its microcode entry point MEP to the microcode ROM 111 via an access bus according to present day practice, the register logic 306 begins executing provided micro instructions M1-M3 corresponding to a first part of a micro instruction sequence and waits for the microcode ROM 302 to begin issuing micro instructions corresponding to a second part of the micro instruction sequence. If no micro instructions are provided in the entry 305 by the translator 301, then the register logic 306 inserts slips into the pipeline of the microprocessor in synchronization with a pipeline clock signal (not shown) until the microcode ROM 302 begins providing micro instructions corresponding to the microcode entry point provided by the early access logic 303 over bus MEP1. If no microcode entry point MEP is provided in the entry 305, then the register logic 306 accesses operands within the register file as directed by provided micro instructions M1-M3 and provides the micro instructions M1-M3 and operands to a following stage (not shown) within the microprocessor according to the present invention in synchronization with the pipeline clock signal. If both micro instructions M1-M3 and a microcode entry point MEP are provided by the entry 305, then the register logic 306 accesses operands within the register file as directed by the micro instructions M1-M3 and provides the micro instructions M1-M3 and operands to the following stage in synchronization with the pipeline clock signal while waiting for the microcode ROM 302 to supply additional micro instructions for execution via bus MIC2. In this manner, combined direct translation and microcode ROM lookup are employed to improve pipeline efficiency by maintaining a consistent flow of micro instructions to subsequent stages (not shown) of the microprocessor. In contrast to present day designs, however, the early access logic 303 is provided to start an access cycle within the microcode ROM 302 prior to when an entry 305 is provided to the register logic 306 thus precluding any slips from being otherwise inserted into the pipeline due to microcode ROM access delay that is greater than that provided for by configuration of the translator 301 and the micro instruction queue 304. In the exemplary embodiment shown in FIG. 3, the early access logic 303 evaluates a last entry 305 within the queue 304 to compensate for a microcode ROM access delay that is four clock cycles. This embodiment will allow for consistent flow of micro instructions to the register logic 306 for a translator 301 that provides three micro instructions M1-M3 plus a microcode entry point MEP to a similarly configured micro instruction queue 304. The present invention additionally comprehends other configurations of the translator 301, microcode ROM 302, and micro instruction queue 304 to provide for precluding pipeline slips. In one embodiment, a microcode entry point MEP from a selected entry 305 is provided early to the microcode ROM 302 by the early access logic 303, where the selected entry 305 is positioned within the queue 304 a number of entries 305 prior to transfer to the register logic 306 that are equal to the number of excess clock cycles exhibited by the microcode ROM access delay over than already compensated for by configuration of the translator 301 and micro instruction queue 305. For example, if two excess clock cycles must be absorbed, then the early access logic 303 takes the entry point MEP from the next-to-last entry 305 rather than from the last entry 305 immediately prior to the register logic 306. And so on.

In addition to the advantage of absorbing excess microcode ROM access delay, the present invention provides the advantage of overcoming a multiple-cycle stall that is issued to the register stage for reasons other than those discussed herein.

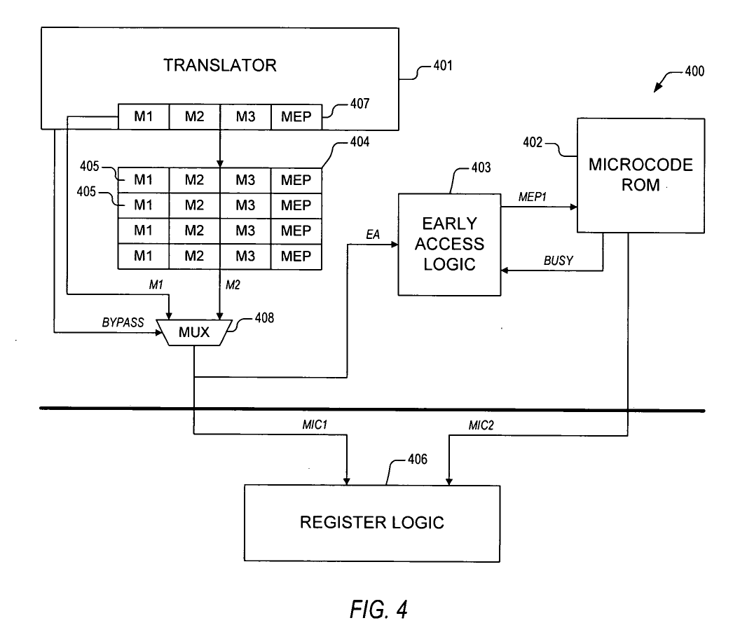

Turning to FIG. 4, a block diagram is presented of an alternative embodiment 400 of the present invention that supports bypass of a micro instruction queue 404 if all of its entries 405 are empty. The alternative embodiment 400 includes a translator 401 that is coupled to the micro instruction queue 404. The translator 401 includes a bypass queue entry 407 and comprises logic, circuits, devices, or microcode (i.e., micro instructions or native instructions), or a combination of logic, circuits, devices, or microcode, or equivalent elements that are employed to directly translate instructions into associated sequences of micro instructions. The elements employed to perform direct translation within the translator 401 may be shared with other circuits, microcode, etc., that are employed to perform other functions within a microprocessor according to the present invention. The micro instruction queue 404 comprises a plurality of entries 405, where each of the entries 405 provides for routing of a plurality of micro instructions M1-M3 along with a corresponding microcode entry point MEP. In one embodiment, the micro instruction queue 404 comprises four entries 405 and each of the four entries 405 provides for three micro instructions M1-M3 and a corresponding microcode entry point MEP. The last entry 405 of the queue 404 is routed to a mux 408 via bus M2. In addition, the bypass queue entry 407 is routed to the mux 408 via bus M1. A bypass signal BYPASS provided by the translator 401 directs the mux 408 to route either the last entry 405 or the bypass entry 407 to register logic 406 via bus MIC1.

Early access logic 403 is operatively coupled to bus MIC1 via bus EA and to a microcode ROM 402 via bus MEP1 and signal BUSY. Micro instructions are provided from the microcode ROM 402 to the register logic 406 via bus MIC2.

In operation, elements of the alternative embodiment 400 according to the present invention functions in a manner substantially similar to like-numbered and like-named elements of the embodiment described with reference to FIG. 3, where the hundreds digit is a “4” rather than a “3.” The difference between the two embodiments 300, 400 is that the alternative embodiment 400 provides for bypassing the micro instruction queue 404 altogether when it is empty. This situation can occur when stalls upstream from the translator 401 result in all of the queue entries 405 being transferred to the register logic 406 during the stalls.

In the alternative embodiment 400, a microcode entry point MEP is picked by the early access logic 403 from the output of the mux 408 rather than from an entry 405 in the queue 404. Thus, the entry point MEP is either from a queue entry 405 or from the bypass entry 407. It is noted that although the last queue entry 405 is coupled to the mux 408 via bus M2, the present invention contemplates other entries 405 coupling to the mux 408 via M2 to compensate for more delay exhibited by the ROM 402 as was discussed with reference to FIG. 3.

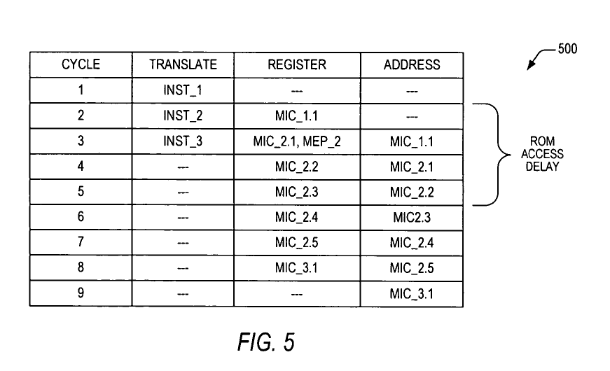

Now referring to FIG. 5, a table 500 is presented illustrating translation of several instructions into corresponding sequences of micro instructions by a microprocessor according to the present invention. The table 500 depicts three columns TRANSLATE, REGISTER, ADDRESS that correspond to like-named stages of a microprocessor according to the present invention that incorporates the embodiments of FIG. 4 or FIG. 5. To focus on how the present invention overcomes the problems previously discussed with reference to a present day microprocessor, columns associated with a fetch stage and stages following the address stage are not shown. In addition, a column CYCLE is depicted showing cycles of a pipeline clock signal that is employed by the microprocessor to route instructions and micro instructions through its pipeline stages. Instructions before or after those of interest are designated “ - - - .” Inserted pipeline slips are designated “ * * * .”

During cycle 1, a first instruction INST_1 is provided from the fetch stage to the translate stage. Therein, the first instruction INST_1 is directly translated into a single corresponding micro instruction MIC_1.1, which is provided to an entry 305, 405 in the micro instruction queue 304, 404. For illustrative purposes, assume for this example that the micro instruction queue 304, 404 only has one entry 305, 405 although it is noted that the present invention contemplates any instruction queue size that is commensurate with pipeline staging in a microprocessor according to the present invention to preclude pipeline starvation due to upstream stall events.

During cycle 2, the first micro instruction MIC_1.1 is provided to the register stage 103. In addition, a second instruction INST_2 is provided to the translate stage 102. Therein, INST_2 is directly translated by the translator 301, 401 into a first part of a corresponding micro instruction sequence having three micro instructions MIC_2.1:3 along with a microcode entry point MEP_2 that points to locations in the microcode ROM 302, 402 containing a second part MIC_2.4:5 of the corresponding micro instruction sequence. In this example, the second part of MIC_2.4:5 of the corresponding micro instruction sequence consists of two micro instructions MIC_2.4, MIC_2.5 for clarity purposes, although one skilled in the art will appreciate that the second part could consist of perhaps hundreds of micro instructions. The three micro instructions MIC_2.1:3 along with the microcode entry point MEP_2 are then provided as an entry 305, 405 in the micro instruction queue 304, 404. In addition during cycle 2, the microcode entry point MEP 2 is evaluated by early access logic 303, 403 and is provided to the microcode ROM 302, 402 prior to the cycle in which the entry 305, 405 is provided to register logic 306, 406. Thus, microcode ROM access is initiated early to preclude slips in the pipeline.

During cycle 3, MIC_1.1 is provided to the address stage. Also during cycle 3, the register stage retrieves the queue entry 305, 405 generated during cycle 2. The register logic 306, 406 executes a first of the three micro instructions MIC_2.1 and holds the other two micro instructions MIC_2.2:3 in a holding register (not shown) or other means of buffering for execution in subsequent cycles. In addition, the translate stage 102 begins direct translation of a third instruction INST_3 into a corresponding micro instruction MIC_3.1, which is placed into the micro instruction queue 304, 404.

During cycle 4, the first micro instruction MIC_2.1 from the first part MIC_2.1:3 of the micro instruction sequence corresponding to the second instruction INST_2 is issued to the address stage. During this cycle, the register logic 306, 406 executes the second micro instruction MIC_2.2 and continues to wait for the microcode ROM 302, 402 to supply the second part MIC_2.4:5 of the micro instruction sequence associated with the microcode entry point MEP_2.

During cycle 5, the second micro instruction MIC_2.2 from the first part MIC_2.1:3 is issued to the address stage for execution. In addition during this cycle, the register logic 306, 406 executes the third micro instruction MIC_2.3 and continues to wait for the microcode ROM 302, 402 to supply the second part MIC_2.4:5 of the micro instruction sequence associated with the microcode entry point MEP_2.

During cycle 6, the third micro instruction MIC_2.3 from the first part MIC_2.1:3 is issued to the address stage 104 for execution. In addition during this cycle, because MEP_2 was provide to the microcode ROM 302, 402 prior to provision of the entry 305, 405 to the register logic 306, 406, the register logic 306, 406 receives MIC_2.4 from the microcode ROM 302, 402 during this cycle. In contrast to the microprocessor 100 described with reference to FIGS. 1-2, a microprocessor according to the present invention does not incur a slip during this cycle.

During cycle 7, MIC_2.4 is provided to the address stage and MIC_2.5 is supplied to the register logic 306, 406 from the microcode ROM 302, 402.

During cycle 8, MIC_2.5 is provided to the address stage and the register logic 306, 406 retrieves MIC_3.1 from the micro instruction queue 304, 404.

The example of FIG. 5 is provided to illustrate how the problems noted by the present inventors with respect to microcode ROM access delay are overcome by the present invention. More specifically, the slip * * * that was propagated to the address stage 104 during cycle 7 of the example discussed with reference to FIG. 2 are now absorbed according to the present invention by accessing the microcode ROM 302, 402 prior to providing an entry to register logic 306, 406. Decreased application program speed and other pipeline inefficiencies due to an instruction queue configuration that provides only up to three micro instructions and a microcode entry point that must interoperate with a microcode ROM which exhibits a 4-cycle access delay are now overcome by the present invention. It is noted again, however, that the specific number of micro instructions M1-M3 within the exemplary micro instruction queue 304, 404 and the access delay of the microcode ROM 302, 402 have been selected to teach relevant aspects of the present invention. The present invention contemplates precluding access delays that correspond to other micro instruction queue entry sizes and microcode ROM access delays other than those shown. For instance, if the exemplary microcode ROM 302, 402 exhibited a 10-cycle access delay and the exemplary micro instruction queue entry 305, 405 provided five micro instructions and a corresponding microcode entry point, then early access logic 303, 403 would be configured to provide a microcode entry point MEP to the microcode ROM 302, 402 that corresponds to an entry 305, 405 that is five entries up from a last entry 305, 405.

Those skilled in the art should appreciate that they can readily use the disclosed conception and specific embodiments as a basis for designing or modifying other structures for carrying out the same purposes of the present invention, and that various changes, substitutions and alterations can be made herein without departing from the spirit and scope of the invention as defined by the appended claims.

What is claimed is:

1. A microprocessor apparatus, for precluding a pipeline stall due to microcode ROM access delay, the microprocessor apparatus comprising:
a plurality of micro instruction queue entries, each corresponding to an instruction, and said each comprising a plurality of micro instructions and a microcode entry point; and
early access logic, coupled to said micro instruction queue, configured to employ said microcode entry point to access a microcode ROM prior to when said microcode entry point is provided to register logic, whereby said microcode ROM provides a first micro instruction to said register logic when said first micro instruction is required by said register logic.

2. The microprocessor apparatus as recited in claim 1, wherein said each of said plurality of micro instruction queue entries is provided in order to said register logic.

3. The microprocessor apparatus as recited in claim 2, wherein said plurality of micro instruction queue entries comprises four micro instruction queue entries.

4. The microprocessor apparatus as recited in claim 1, wherein said plurality of micro instructions comprises three micro instructions.

5. The microprocessor apparatus as recited in claim 4, wherein the microcode ROM access delay comprises four clock cycles.

6. The microprocessor apparatus as recited in claim 1, wherein said early access logic employs said microcode entry point when said microcode entry point is within a bottom micro instruction queue entry, said bottom micro instruction queue entry comprising one of said each, and wherein said bottom micro instruction queue entry will be provided to said register logic during a next clock cycle.

7. The microprocessor apparatus as recited in claim 1, further comprising:
a translator, coupled to said plurality of micro instruction queue entries, configured to generate said each.

8. The microprocessor apparatus as recited in claim 7, wherein said translator is configured to provide a generated micro instruction queue entry to a top micro instruction queue entry, wherein said top micro instruction queue entry comprises one of said each.

9. The microprocessor apparatus as recited in claim 7, wherein said translator is configured to provide a generated micro instruction queue entry to a mux, and, when said plurality of micro instruction queue entries is empty, said mux provides said generated micro instruction queue entry to said register logic during a next clock cycle.

10. The microprocessor apparatus as recited in claim 9, wherein said early access logic employs a bypass microcode entry point corresponding to said generated micro instruction queue entry.

11. An apparatus for absorbing pipeline stalls associated with microcode ROM access delay, the apparatus comprising:
a micro instruction queue, for providing a plurality of queue entries to register logic, each of said plurality of queue entries comprising:
first micro instructions, all of said first micro instructions corresponding to an instruction; and
a microcode entry point, coupled to said first micro instructions, configured to point to second micro instructions stored within a microcode ROM; and
early access logic, coupled to said micro instruction queue, configured to employ said microcode entry point to access said microcode ROM prior to when said each of said plurality of queue entries is provided to said register logic, whereby a first one of said second micro instructions is provided to said register logic when said first one of said second micro instructions is required by said register logic.

12. The apparatus as recited in claim 11, wherein said each of said plurality of queue entries is provided in order to said register logic.

13. The apparatus as recited in claim 12, wherein said plurality of queue entries comprises four queue entries.

14. The apparatus as recited in claim 11, wherein said first micro instructions comprise three micro instructions.

15. The apparatus as recited in claim 14, wherein the microcode ROM access delay comprises four clock cycles.

16. The apparatus as recited in claim 11, wherein said early access logic employs said microcode entry point when said microcode entry point is within a bottom queue entry, said bottom queue entry comprising one of said each, and wherein said bottom queue entry will be provided to said register logic during a next clock cycle.

17. The apparatus as recited in claim 11, further comprising:
a translator, coupled to said plurality of queue entries, configured to generate said each.

18. The apparatus as recited in claim 17, wherein said translator is configured to provide a generated queue entry to a top queue entry, wherein said top queue entry comprises one of said each.

19. The apparatus as recited in claim 17, wherein said translator is configured to provide a generated queue entry to a mux, and, when said plurality of queue entries is empty, said mux provides said generated queue entry to said register logic during a next clock cycle.

20. The apparatus as recited in claim 19, wherein said early access logic employs a bypass microcode entry point corresponding to said generated micro instruction queue entry.

21. A method for precluding microprocessor pipeline stalls resulting from microcode ROM access delay, the method comprising:
obtaining a microcode entry point from within one of a plurality of micro instruction queue entries, the one of the plurality of micro instruction queue entries comprising first micro instructions; and
employing the microcode entry point to access second micro instructions within a microcode ROM, wherein said employing is performed prior to when the one of the plurality of micro instruction queue entries is routed to a following pipeline stage, and whereby said employing enables the second micro instructions to be provided to the following pipeline stage without incurring the microprocessor pipeline stalls.

22. The method as recited in claim 21, further comprising:
issuing the plurality of micro instruction queue entries in order to the following pipeline stage.

23. The method as recited in claim 22, wherein the plurality of micro instruction queue entries comprises four micro instruction queue entries.

24. The method as recited in claim 21, wherein the first micro instructions comprises three micro instructions.

25. The method as recited in claim 24, wherein the microcode ROM access delay comprises four clock cycles.

26. The method as recited in claim 21, wherein said obtaining comprises:
Selecting the microcode entry point from within a bottom micro instruction queue entry, the bottom micro instruction queue entry comprising the one of a plurality of micro instruction queue entries, wherein the bottom micro instruction queue entry will be provided to the following pipeline stage during a next clock cycle.

27. The method as recited in claim 21, further comprising:
generating a current microcode entry point.

28. The method as recited in claim 27, wherein said generating provides the current microcode entry point to a top micro instruction queue entry, and wherein the top micro instruction queue entry comprises another of the plurality of micro instruction queue entries.

29. The method as recited in claim 27, wherein said generating provides the current microcode entry point to a mux, and, when the plurality of micro instruction queue entries is empty, the mux provides the current microcode entry point to the following pipeline stage during a next clock cycle.
